(19) United States
(12) Patent Application Publication
(10) Pub. No.: US 2013/0162396 A1
(43) Pub. Date: Jun. 27, 2013

(54) Automatically Controllable Smart Stroller or Wheelchair

(71) Applicant: National Kaohsiung University of Applied Science, Kaohsiung (TW)

(72) Inventor: Chih-Hsiung Yang, Kaohsiung (TW)

(73) Assignee: National Kaohsiung University of Applied Sciences, Kaohsiung (TW)

(21) Appl. No.: 13/684,634

(22) Filed: Nov. 26, 2012

(30) Foreign Application Priority Data
Dec. 22, 2011 (TW) 100147941
Jan. 16, 2012 (TW) 101101577

(51) Int. Cl. B60L 15/20; B60R 25/00; B60J 1/20

(52) U.S. Cl. CPC B60L 15/20; B60J 1/2011; B60R 25/002
USPC 340/5.81; 701/22; 701/49

(57) ABSTRACT

A smart stroller or wheelchair device includes a frame, a body-movement detecting unit provided on the frame, a drive control unit and a drive unit. The drive control unit electrically connects with the body-movement detecting unit and the drive unit. The body-movement detecting unit is operated to detect a position and a distance of an operator, thereby the drive control unit synchronously controlling the drive unit to move the frame a predetermined distance. In an embodiment, the stroller or wheelchair device includes a light sensor unit, a canopy control unit and a canopy drive unit. In an alternative, the stroller or wheelchair device includes a backrest adjustment mechanism, a recognition system or a safety guard system.

### BACKGROUND OF THE INVENTION

1. Field of the Invention

The present invention relates to an automatically controllable smart stroller or wheelchair for automatically following an operator or user. More particularly, the present invention relates to the automatically controllable smart stroller or wheelchair having a RFID (radio frequency identification) system and an automatic canopy operation system.

2. Description of the Related Art

Taiwanese Patent Pub. No. M376474, entitled “Solar power stroller,” discloses: a stroller including a stroller body, a control handle, a transmission gear set, a solar cell plate, a battery set, a shock absorber set and a wheel set. The stroller body connects with the transmission gear set, the battery set, the shock absorber set and the wheel set. The control handle connects with the stroller body and is applied to control the speeds and directions of the transmission gear set which is provided to move the stroller body forward or backward. The solar cell plate is provided to supply electricity to the battery set which is supply power to the gear set. The shock absorber set is provided to absorb and reduce vibrations while attaching to the wheel set.

Another U.S. Pat. No. 5,873,425, entitled “Motorized stroller with rear wheel drive assembly,” discloses: a rear wheel drive assembly of a motorized stroller including a transmission unit, a bidirectional motor, a battery unit and a control unit. The transmission unit includes a gear housing to be mounted on a rear wheel support rod of a stroller frame, and a speed reducing gear set mounted operably in the gear housing. The gear set includes an input gear, an output gear driven rotatably by the input gear, and a knurled roller mounted coaxially on one side of the output gear and extending partially out of an open bottom end of the gear housing. The knurled roller contacts the tire portion of a rear wheel on the support rod such that rotation of the input gear results in corresponding rotation of the knurled roller in order to generate friction between the knurled roller and the rear wheel. The motor is mounted on the gear housing and drives rotatably the input gear. The battery unit includes a battery holder mounted on the stroller frame and adapted to receive a storage battery therein. The control unit is connected electrically to the motor and the electrical contacts on the battery holder, and is operable so as to control direction of rotation of the drive shaft of the motor to control, in turn, forward and backward movement of the stroller frame.

However, there is a need of improving the solar power stroller disclosed in Taiwanese Patent Pub. No. M376474 or the motorized stroller disclosed in U.S. Pat. No. 5,873,425 for providing a recognition system, an automatic drive stroller or an automatic canopy operation system on the stroller, for example. The above-mentioned patent publications are incorporated herein by reference for purposes including, but not limited to, indicating the background of the present invention and illustrating the state of the art.

As is described in greater detail below, the present invention intends to provide an automatically controllable smart stroller or wheelchair. The smart stroller is provided with a recognition system, an automatic drive system or an automatic canopy operation system a in such a way as to mitigate and overcome the above problem.

### SUMMARY OF THE INVENTION

The primary objective of this invention is to provide an automatically controllable smart stroller or wheelchair with a synchronous drive mechanism for automatically following an operator or user. A body-movement detecting unit is provided to detect an operator's movement so that a drive control unit is capable of synchronously operating a stroller drive system. Accordingly, the stroller system is successful in automatically following the operator or user.

Another objective of this invention is to provide an automatically controllable smart stroller or wheelchair with an automatic control mechanism. A light sensor unit is provided to measure the intensity of light, thereby controlling a canopy operation system for adjusting a stroller canopy. Accordingly, the canopy operation system is successful in enhancing the automatic function of the stroller.

Another objective of this invention is to provide an automatically controllable smart stroller with a safety mechanism. A recognition system is provided to identify an operator's ID to allow operating a stroller drive system or a stroller lock system. Accordingly, the recognition system is successful in enhancing the safety function of the stroller.

The automatically controllable smart stroller in accordance with an aspect of the present invention includes:

a stroller frame;

a body-movement detecting unit provided on the stroller frame;

a drive control unit electrically connecting with the body-movement detecting unit; and

a stroller drive unit electrically connecting with the drive control unit;

wherein the body-movement detecting unit is operated to detect a position and a distance of an operator, thereby the drive control unit synchronously controlling the stroller drive unit to move the stroller frame a predetermined distance to follow the operator.

In a separate aspect of the present invention, the drive control unit includes a first single-chip microprocessor and a second single-chip microprocessor which are selected from an AVR single-chip microprocessor.

In a further separate aspect of the present invention, the body-movement detecting unit includes a first ultrasonic sensor unit and a second ultrasonic sensor unit.

In yet a further separate aspect of the present invention, the stroller drive unit includes an H-bridge driver, a first speed-reducing gear motor and a second speed-reducing gear motor.

In yet a further separate aspect of the present invention, the stroller drive unit connects with an emergency stop button.

The automatically controllable smart stroller in accordance with an aspect of the present invention includes:

a stroller frame;

a light sensor unit provided on the stroller frame;

a canopy control unit electrically connecting with the light sensor unit; and

a canopy drive unit electrically connecting with the canopy control unit;

wherein the light sensor unit is operated to measure the intensity of light, thereby the canopy control unit controlling the canopy drive unit to drive a canopy to a predetermined position.

In yet a further separate aspect of the present invention, the light sensor unit is selected from a photo resistor member.

In yet a further separate aspect of the present invention, the canopy drive unit includes a servo motor.

In yet a further separate aspect of the present invention, the stroller frame further includes a backrest adjustment mechanism.

In yet a further separate aspect of the present invention, the backrest adjustment mechanism includes a servo motor.

The automatically controllable smart stroller in accordance with an aspect of the present invention includes:

a stroller system;

a recognition system provided in the stroller system, with the recognition system including at least one first member; and

at least one second member provided as a user's ID;

wherein if the first member is operated to read the second member and thus to successfully identify the user's ID, the operation of the stroller system is allowed.

In yet a further separate aspect of the present invention, the stroller system further includes a stroller lock system which is unlocked if the user's ID is successfully confirmed.

In yet a further separate aspect of the present invention, the stroller system further includes a warning unit which is operated to generate a warning signal and to start a power saving module if the first member fails to read the user's ID.

In yet a further separate aspect of the present invention, the recognition system is selected from a RFID system.

In yet a further separate aspect of the present invention, the stroller system further includes a music player system which is applied to play a predetermined file, or a toy device.

In yet a further separate aspect of the present invention, the music player system is selected from a MP3 player.

In yet a further separate aspect of the present invention, the stroller system further includes a clock alarm unit to remind the user feeding a baby.

In yet a further separate aspect of the present invention, the stroller system further includes a safety guard system connecting with a stroller lock system.

Further scope of the applicability of the present invention will become apparent from the detailed description given hereinafter. However, it should be understood that the detailed description and specific examples, while indicating preferred embodiments of the invention, are given by way of illustration only, since various will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a front perspective view of an automatically controllable smart stroller in accordance with a first preferred embodiment of the present invention.

FIG. 2 is a rear perspective view of the automatically controllable smart stroller in accordance with the first preferred embodiment of the present invention.

FIG. 3 is a side view of the automatically controllable smart stroller in accordance with the first preferred embodiment of the present invention.

FIG. 4 is a block diagram of a drive control unit applied in the automatically controllable smart stroller in accordance with the first preferred embodiment of the present invention.

FIG. 5 is a block diagram of a canopy control unit applied in the automatically controllable smart stroller in accordance with the first preferred embodiment of the present invention.

FIG. 6 is a front perspective view of the automatically controllable smart stroller in accordance with a second preferred embodiment of the present invention.

FIG. 7 is a block diagram of the drive control unit applied in the automatically controllable smart stroller in accordance with a third preferred embodiment of the present invention.

FIG. 8 is a front perspective view of the automatically controllable smart stroller in accordance with a fourth preferred embodiment of the present invention.

FIG. 9 is a rear perspective view of the automatically controllable smart stroller in accordance with the fourth preferred embodiment of the present invention.

FIG. 10 is a block diagram of the drive control unit applied in the automatically controllable smart stroller in accordance with the fourth preferred embodiment of the present invention.

### DETAILED DESCRIPTION OF THE INVENTION

It is noted that an automatically controllable smart stroller in accordance with the preferred embodiment of the present invention can be applicable to various foldable strollers or wheelchairs, various electric or non-electric strollers and related technical fields; furthermore, the automatically controllable smart stroller in accordance with the preferred embodiment of the present invention is suitable for providing multiple functions, for example: automatic drive operation or automatic canopy control, which are not limitative of the present invention.

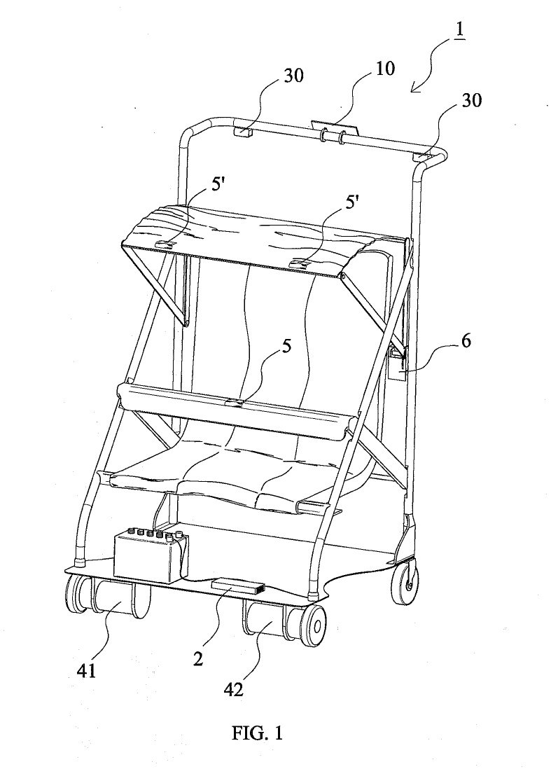

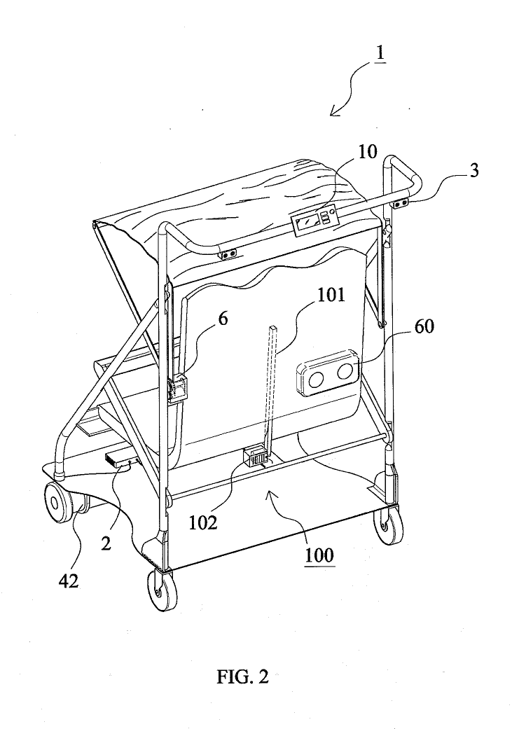

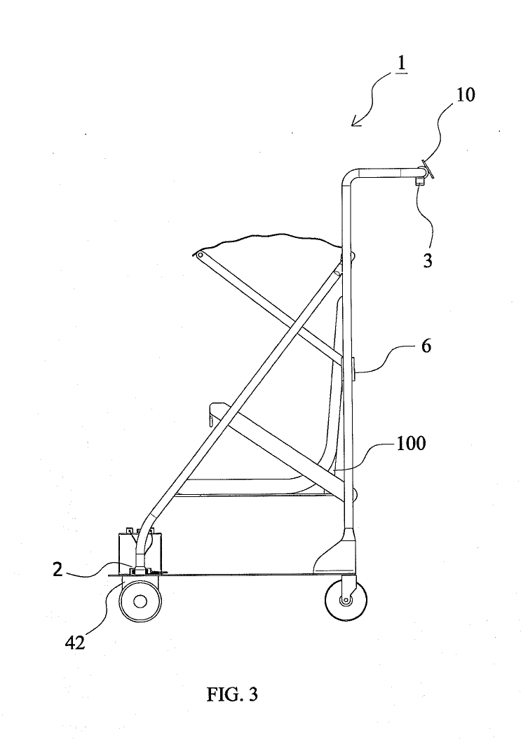

Referring initially to FIGS. 1 through 3, the automatically controllable smart stroller (wheelchair) of the first preferred embodiment of the present invention includes a stroller frame (e.g. wheelchair frame) 1 provided with a chair seat, a hand grip, a plurality of wheels and a canopy. The stroller frame or the wheelchair frame 1 further includes a control panel 10 mounted on the hand grip of the stroller frame 1 or a wireless remote control panel.

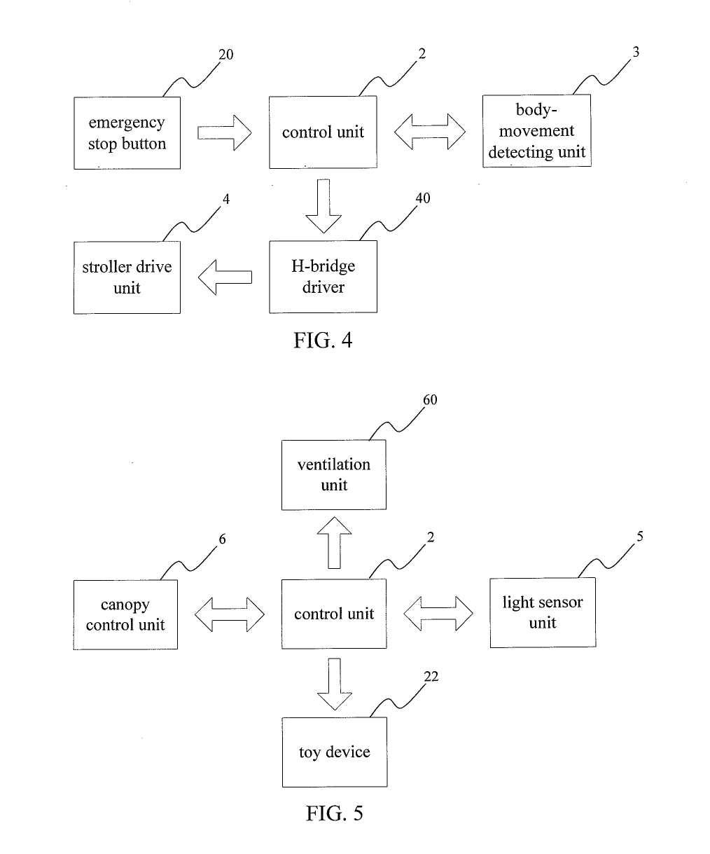

Referring now to FIG. 4, the automatically controllable smart stroller of the first preferred embodiment of the present invention includes a control unit 2, a body-movement detecting unit 3 and a stroller drive unit 4. The body-movement detecting unit 3 and the stroller drive unit 4 are capable of communicating with the control unit 2. Referring now to FIG. 5, the automatically controllable smart stroller of the first preferred embodiment of the present invention further includes a light sensor unit 5 and a canopy control unit 6 communicated with the control unit 2.

Referring back to FIGS. 1 through 4, the control unit 2 is mounted on the stroller frame 1 and the control unit 2 electrically connects with the body-movement detecting unit 3 and the stroller drive unit 4 so that the body-movement detecting unit 3 is operated to detect a movement of a human body and to output a signal to the control unit 2. The control unit 2 includes a first single-chip microprocessor and a second single-chip microprocessor which are selected from an Atmel AVR single-chip microprocessor (manufactured by Atmel Corporation, an American manufacturer of semiconductors) and are applied to calculate a distance between an operator (i.e. user) and the body-movement detecting unit 3 and to determine a position of the operator. The control unit 2 further connects with an emergency stop button 20 so as to stop operating the body-movement detecting unit 3 and the stroller drive unit 4 immediately. By way of example, the emergency stop button 20 is provided on the control panel 10, the stroller frame 1 or other suitable positions (i.e. hand grip).

Still referring to FIGS. 1 through 4, the body-movement detecting unit 3 includes a first ultrasonic sensor unit 30 and a second ultrasonic sensor unit 30 which are mounted on two opposite sides (left and right sides) of the hand grip. The first ultrasonic sensor unit 30 and the second ultrasonic sensor unit 30 are arranged to face rearward so that the movement of the operator at the rear side of the stroller is detected. In a preferred embodiment, the body-movement detecting unit 3 is combined with or selected from other detection members, thermal sensors for example.

Still referring to FIGS. 1 through 4, the stroller drive unit 4 includes an H-bridge driver (full bridge driver) 40, a first speed-reducing gear motor 41, a second speed-reducing gear motor 42 and other motors. The first speed-reducing gear motor 41 and the second speed-reducing gear motor 42 are provided on each front wheel of the stroller frame 1 respectively. The control unit 2 is applied to operate the H-bridge driver 40 for synchronously or asynchronously controlling start and stop operations of the first speed-reducing gear motor 41 and the second speed-reducing gear motor 42. When the control unit 2 is operated to start the first speed-reducing gear motor 41 and the second speed-reducing gear motor 42 synchronously, the stroller is driven to move forward or rearward. On the other hand, when the control unit 2 is operated to drive the first speed-reducing gear motor 41 and the second speed-reducing gear motor 42 in different speeds, the stroller is driven to turn left or right, or by turning rear wheels to left or right.

Referring again to FIG. 4, when the body-movement detecting unit 3 detects the distance and position of the operator for following the movement of the operator, the control unit 2 is automatically operated to control the H-bridge driver 40 of the stroller drive unit 4 to move the stroller frame 1 to a predetermined position. Accordingly, the stroller can be automatically driven and moved according to the movement of the operator. Once the emergency stop button 20 is pressed, the automatic drive mode is ceased and the stroller until is stopped until restarting the automatic drive mode.

Referring again to FIGS. 1 through 3 and 5, in order to automatically operate the canopy, the stroller frame 1 is provided with the light sensor unit 5 and the canopy control unit 6. By way of example, the light sensor units 5, 5′ are mounted on a frame member of the stroller frame 1 or on the canopy to detect the intensity and different incident angles of outdoor sunlight. The light sensor units 5, 5′ are selected from at least one or a plurality of photo resistor members or other light sensors. The light sensor unit 5, 5′ connects with the control unit 2 and is actuated to transmit a signal to the control unit 2 which further connects with a ventilation unit (e.g. fan) 60 for controlling ventilation operation according to the signal from the light sensor unit 5, 5′.

Referring again to FIG. 5, the canopy control unit 6 includes a servo motor and a transmission gear set and electrically connects with the control unit 2. The canopy control unit 6 is provided on a predetermined position of the stroller frame 1 to control the canopy control unit 6 for controllably expanding or retracting the canopy with a predetermined angle according to the signal from the light sensor unit 5.

Still referring again to FIG. 5, the light sensor units 5, 5′ located at different positions detect sunlight and then transmit signals to the control unit 2, thereby generating the intensity and the incident angle of sunlight. Accordingly, the control unit 2 is operated to control the canopy control unit 6 to expand the canopy to a predetermined angle with respect to the upper portion of the stroller frame 1.

Referring again to FIGS. 1 through 3 and 5, the stroller frame 1 further includes a backrest adjustment mechanism 100 which includes an adjustable backrest support 101 connected with a backrest plate and a servo motor 102. In operation, the servo motor 102 is controllably driven to adjust the adjustable backrest support 101 and the backrest plate to a predetermined angle with respect to the seat.

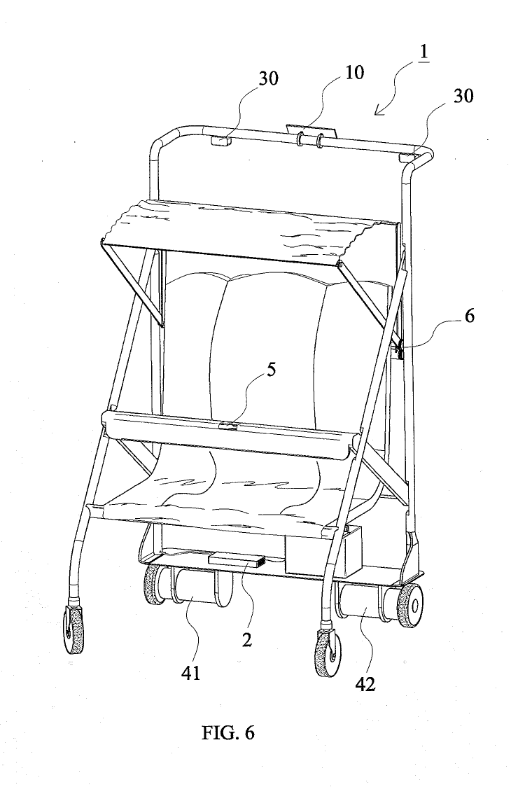

Turning now to FIG. 6, the automatically controllable smart stroller of the second preferred embodiment of the present invention includes two rear wheels and each of which is combined with the first speed-reducing gear motor 41 and the second speed-reducing gear motor 42. By way of example, the first speed-reducing gear motor 41 and the second speed-reducing gear motor 42 mechanically connect to the sides of the rear wheels respectively.

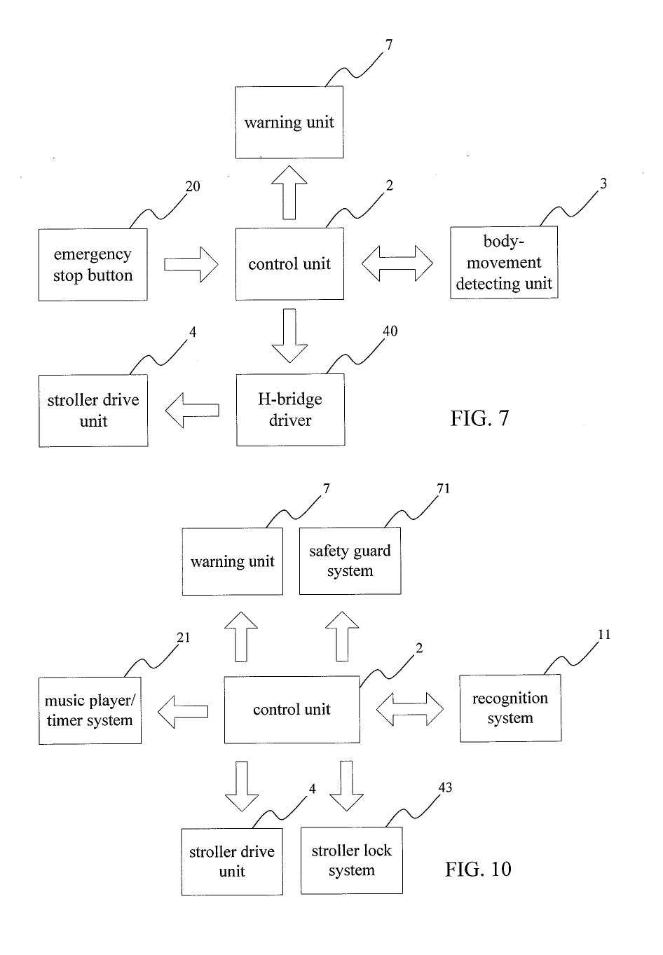

Turning now to FIG. 7, the automatically controllable smart stroller of the third preferred embodiment of the present invention further includes a warning unit 7 which is operated to generate a warning signal to transmit to the control unit 2. The warning unit 7 further includes a buzzer or a flash light. If the movement exceeds the detection scope of the body-movement detecting unit 3, it fails to detect the movement of the operator and the control unit 2 is operated to cease the automatic drive mode. Meanwhile, the warning unit 7 can generate the warning signal to remind the operator to return to the detection scope of the body-movement detecting unit 3. Once the body-movement detecting unit 3 detects the movement of the operator again, the control unit 2 is operated to continue the automatic drive mode.

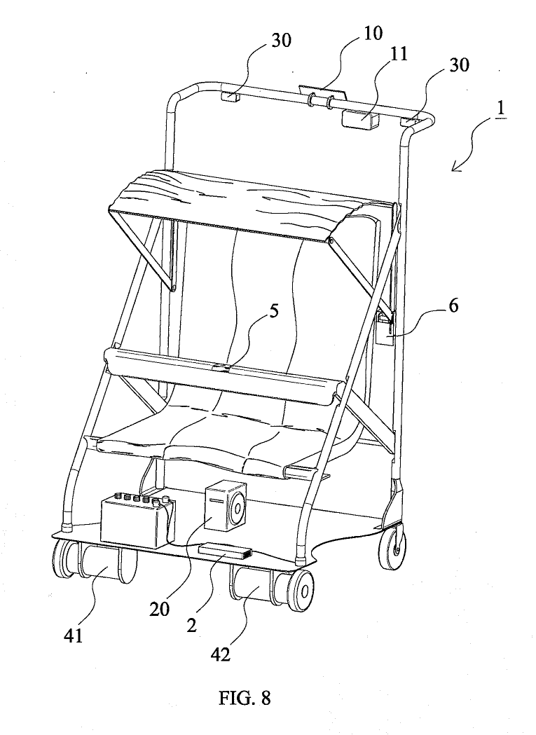

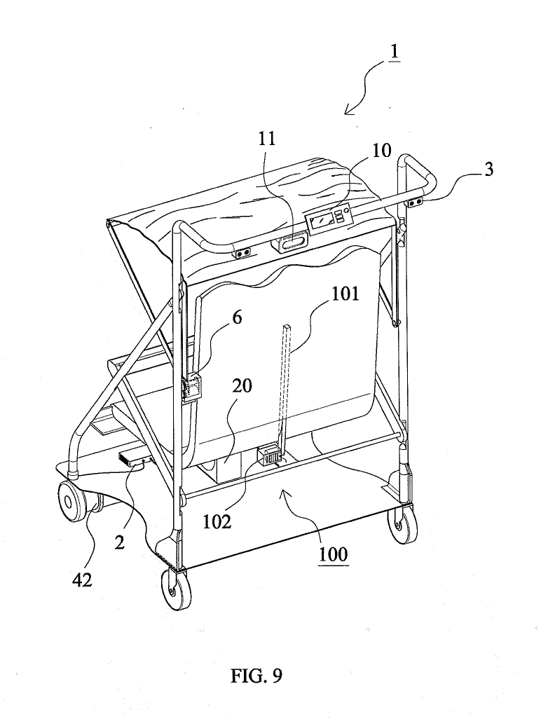

Turning now to FIGS. 8 through 10, the automatically controllable smart stroller of the fourth preferred embodiment of the present invention further includes at least one recognition system 11 electronically connecting with the control panel 10 or the control unit 2. The recognition system 11 is provided on the hand grip of the stroller frame 10 or other positions, frame rods or supports for example.

Still referring to FIGS. 8 through 10, in recognition operation, if the recognition system 11 is operated to read and to successfully confirm a user's ID or to input a password or the like with a series of confirmation steps, the user is allowed to operate the stroller. Conversely, if the recognition system 11 fails to confirm the user's ID; the whole system of the stroller cannot be operated. The power of the stroller is further cut off within a predetermined time or the stroller is selectively operated to start a power saving module. Consequently, the whole system of the stroller cannot be driven for safety.

Still referring to FIGS. 8 through 10, the recognition system 11 is selected from a RFID system including a RFID reader (i.e. first member) and a RFID tag (i.e. second member). The RFID reader is mounted on the stroller frame 1 while the RFID tag is carried with a user as a user's ID. For example, the recognition system 11 is selected from a fingerprint recognition system, a voice recognition system, a face recognition system or a biometric recognition system.

Referring back to FIGS. 4, 5 and 8, the automatically controllable smart stroller of the fourth preferred embodiment of the present invention further includes at least one music player/timer system 21 which is applied to play a (digital) file, controlled by the control unit 2 and operated via the control panel 10, or at least one toy device 22 which is controlled by the control unit 2 and operated via the control panel 10 if the user's ID is confirmed.

Referring again to FIG. 10, the music player/timer system 21 includes a music player and a timer (clock alarm unit) combined therewith. The music player is operated to play a file of songs and the timer is operated to set a feeding time and to remind the user feeding a baby or, while leaving, to count down a predetermined time to start the power-saving module or to cut off the power supply of the stroller. In a preferred embodiment, the music player is selected from a MP3 player or other players provided with a socket for a memory card (i.e. a SD socket for a SD card) formed on a wall of the music player system 21 which is shown in FIG. 8.

Referring again to FIGS. 4 and 8 through 10, the stroller system further includes a stroller lock system 43 which is unlocked if the user's ID is successfully confirmed. By way of example, the stroller lock system 43 electrically connects with the first speed-reducing gear motor 41 and the second speed-reducing gear motor 42 such that the stroller lock system 43 can be operated to lock or unlock the first speed-reducing gear motor 41, the second speed-reducing gear motor 42 and the wheels. If the recognition system 11 successfully confirms the user's ID, the stroller lock system 43 allows operating the stroller. Conversely, if the recognition system 11 fails to successfully confirm the user's ID, the whole system of the stroller cannot be operated and locked.

Turning now to FIGS. 7 and 8, the stroller system further includes a safety guard system 71 electrically connecting with the warning unit 7 which can warn any user touching or operating the stroller system without passing the recognition operation. The safety guard system 71 further connects with the control unit 2, the stroller drive unit 4 or the stroller lock system 43. Accordingly, once the safety guard system 71 generates a warning signal, the stroller lock system 43 is actuated and the stroller drive unit 4 is locked.

Still referring to FIGS. 7 and 8, if the locked mode or the idling mode of the stroller system continues a predetermined time, the warning unit 7 will generate a warning signal directly to the user or wirelessly to a control center for checking the baby or the disable person seated on the stroller system or the wheelchair system.

Although the invention has been described in detail with reference to its presently preferred embodiment, it will be understood by one of ordinary skills in the art that various modifications can be made without departing from the spirit and the scope of the invention, as set forth in the appended claims.

What is claimed is:

1. An automatically controllable smart stroller or wheelchair device, comprising:
a frame;
a body-movement detecting unit provided on the frame;
a drive control unit electrically connecting with the body-movement detecting unit; and
a drive unit electrically connecting with the drive control unit;
wherein the body-movement detecting unit is operated to detect a position and a distance of an operator, thereby the drive control unit synchronously controlling the drive unit to move the frame a predetermined distance.

2. The stroller or wheelchair device as defined in claim 1, wherein the drive control unit includes at least one microprocessor.

3. The stroller or wheelchair device as defined in claim 1, wherein the body-movement detecting unit includes at least one ultrasonic sensor unit.

4. The stroller or wheelchair device as defined in claim 1, wherein the drive unit includes an H-bridge driver and at least one speed-reducing gear motor.

5. The stroller or wheelchair device as defined in claim 1, wherein the drive unit connects with an emergency stop button.

6. The stroller or wheelchair device as defined in claim 1, further including a light sensor unit, a canopy control unit and a canopy drive unit.

7. The stroller or wheelchair device as defined in claim 1, further including a backrest adjustment mechanism.

8. The stroller or wheelchair device as defined in claim 1, further including a recognition system for recognizing a user's ID.

9. The stroller or wheelchair device as defined in claim 1, further including a safety guard system connecting with a lock system.

10. An automatically controllable smart stroller or wheelchair device, comprising:
a frame;
a light sensor unit provided on the frame;
a canopy control unit electrically connecting with the light sensor unit; and
a canopy drive unit electrically connecting with the canopy control unit;
wherein the light sensor unit is operated to measure the intensity of light, thereby the canopy control unit controlling the canopy drive unit to drive a canopy to a predetermined position.

11. The stroller or wheelchair device as defined in claim 10, wherein the light sensor unit is selected from a photo resistor member.

12. The stroller or wheelchair device as defined in claim 10, wherein the frame further includes a backrest adjustment mechanism.

13. The stroller or wheelchair device as defined in claim 10, further including a ventilation unit connecting with a control unit.

14. An automatically controllable smart stroller or wheelchair device, comprising:
a stroller or wheelchair system;
a recognition system provided on the stroller or wheelchair system, with the recognition system including at least one first member; and
at least one second member provided as a user's ID;
wherein if the first member is operated to read the second member and thus to successfully identify the user's ID, the operation of the stroller or wheelchair system is allowed.

15. The stroller or wheelchair device as defined in claim 14, wherein the stroller or wheelchair system further includes a lock system which is unlocked if the user's ID is successfully confirmed.

16. The stroller or wheelchair device as defined in claim 14, wherein the stroller or wheelchair system further includes a warning unit which is operated to generate a warning signal and to start a power saving module if the first member fails to read the user's ID.

17. The stroller or wheelchair device as defined in claim 14, wherein the recognition system is selected from a RFID system.

18. The stroller or wheelchair device as defined in claim 14, wherein the stroller or wheelchair system further includes a music player system which is applied to play a predetermined file, or a toy device.

19. The stroller or wheelchair device as defined in claim 14, wherein the stroller or wheelchair system further includes a clock alarm unit to remind the user feeding a baby.

20. The stroller or wheelchair device as defined in claim 14, wherein the stroller or wheelchair system further includes a safety guard system connecting with a lock system.
